(19) United States
(12) Patent Application Publication
(10) Pub. No.: US 2008/0319841 A1
(43) Pub. Date: Dec. 25, 2008

(54) Per-Machine Based Shared Revenue Ad Delivery Fraud Detection and Mitigation

(76) Inventors: Robert Ian Oliver, Issaquah, WA (US); Krista L. Johnson, Newcastle, WA (US); Garrett R. Vargas, Sammamish, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(21) Appl. No.: 11/766,605

(22) Filed: Jun. 21, 2007

(51) Int. Cl. G06Q 30/00

(52) U.S. Cl. 705/14

(57) ABSTRACT

A per-machine based owner compensation advertising delivery systems targets advertising content to individual computer machines. Computer owners are compensated by receiving a portion of the per-machine advertising revenue, obtaining subsidized ad software, or by other financial agreements corresponding to ad delivery to a specific computer. The client software responsible for showing the ad content is also responsible for requesting ads from a server of an ad delivery service provider based on a deterministic combination of sequence and timing information that is also known by the server. The server may detect potential client fraud based on the comparing the pattern, frequency, and content of received ad requests to the expected behavior of the client machine, and then take action to mitigate the fraud through various strategies.

### BACKGROUND

Present computer-based advertising delivery systems are directed towards online environments where advertisements are displayed on a web page that a user visits. Displaying the ad (impression-based advertising) or enticing a click from the user on the ad (click-based advertising) results in revenue being allocated to the web page owner for each impression or click.

Concurrently, owners of computers that are used to generate revenue by short-term rentals (e.g., internet café owners, kiosks in airports, etc.) are constantly looking for new ways to increase their business profit. Current strategies include enticing more customers through competitive and/or teaser rates, offering added-value goods such as coffee and snacks, or other such marketing strategies. Computer owners currently do not have access to revenue generated by online website-based advertising delivery systems.

A need exists to create a computer machine-based advertising delivery solution to benefit computer machine owners. Any such advertising delivery solution needs to be robust enough to detect and mitigate fraudulent activity to improve the odds of commercial success. In the case where the owner of a computer running the advertising client on his/her machine has an incentive to artificially drive up advertising activity, a need exists to place constraints in the ad delivery system to minimize the owner's potential (fraudulent) benefit of gaming the system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A per-machine based owner compensation advertising system may provide a way for computer owners to obtain a financial benefit for advertisements displayed on computers that they own, where the owner's compensation may be correlated for each advertisement displayed or exposed on each individual physical machine. One target market for this ad delivery system may be internet café owners, however, other markets may also applicable, such as libraries, computer kiosks in airports, consumer personal computers, and the like. Using the example of an internet café owner, advertisements may be loaded onto one or more computers in his/her café and may be displayed when customers purchase computer time on the machines. Each computer may have an advertising display configuration which may or may not be the same as the other computers. These ad display configurations are correlated to the physical computer machine itself. For example, the wallpaper of a computer may display a series of ads that rotate at a prescribed time interval. Or, after a customer has been using the computer for a predetermined amount of time, a pop-up window may appear to print out a coupon for a free drink from a neighboring restaurant. A marquee bar may appear in a browser tool bar with rolling advertisements of goods available to be purchased in the café. A café owner with several different locations may choose to display different advertising strategies for city and suburban storefronts. Many other per-machine advertising strategies may be possible. Owner compensation may occur through revenue sharing, where a portion of the revenue generated by a specific displayed advertisement on an individual machine may be allotted to the internet café owner. Alternatively, an owner may be compensated via ad-subsidized software, discounts, or other means.

Per-machine based owner compensation advertising may be different than browser-based advertising approaches. Typical browser-based advertising systems may generate revenue by a user actively visiting a website and either viewing or clicking on an advertisement displayed on that website. A portion of the revenue generated by the viewing or clicking of the ad may be allotted to the website host as payment from the advertising company for advertising space on the host website. With the per-machine based owner compensation advertising approach, the ad delivery mechanism is not associated with a website—it is attributed to a physical machine. The user may not be required to take active action (e.g., visit a website); the advertisements may be automatically displayed on the physical computer in the café independent of internet activity. Furthermore, the owner of the physical machine may receive a portion of the advertising revenue or be financially compensated through subsidies or other means. Indeed, the advertising system may not be required to link to a website at all; for example, the advertising may be embedded in the browser bar or the wallpaper of the computer, or the advertising may be embedded when a customer sends a file to a printer in the café. Many other advertising strategies and implementations may be possible. This application, however, does not disclose advertising content, timing, or strategy on the client computers. This application is directed towards the framework on the server of the ad delivery service provider that supports the per-machine based owner compensation advertising system, and associated fraud detection/mitigation strategies for the framework.

The computer owner may enroll with the service provider of per-machine based owner compensation ad delivery thus creating an owner account with the server of the service provider. The owner account may specify compensation agreements, preferences for advertising configurations, computer identifications, physical locations of computers, contact information, and other such administrative information. The preferences for advertising configurations may be forwarded to an ad content service, whose responsibilities may be determining and packaging actual advertising content, timing, and strategy. The ad content service may be on the same server that processed the registration, it may be a different server of the ad delivery service provider, or it may even be managed by a third party.

Based on the owner account information, the ad delivery service provider may then download (or may send using some other mechanism) a local ad module to a site specified by the owner. At the site, the owner or an operator may install the local ad module on each client computer that the owner wishes to use into the per-machine based owner compensation ad delivery system. Each client computer may then be registered at the server, so that advertising activity generated by that client computer may be properly attributed to the owner. The record for the computer in the owner account may maintain data about the client computer, that may include but is not limited to a unique identifier of the physical computer, physical location, an ad configuration, the owner of the computer, request constraints and parameters. The data may be able to be selected and modified by another process, an administrator of the ad delivery service provider, or by the owner/operator beforehand or in real-time via a user interface; the parameters may be predetermined and static; or the parameters may be a mix of the above. The information retained at the server about each client computer may also be stored in various formats such as but not limited to a machine list.

The server may retrieve an ad configuration, send it to the client computer, and correlate it to the client computer's entry in the machine list. The ad configuration may be retrieved from a local database, a remote database, a third party, or some other source. The ad configuration may or may not be created based on input from the ad content server, and may be stored at the local ad module on the client computer. The content of the ad configuration may contain but is not limited to a timestamp and a set of sequences. The set of sequences may contain a first time sequence that lists a series of ad content type and exposure time pairs to be executed once by the client computer. The set of sequences may also contain a continuous sequence that lists a series of ad content type and exposure time pairs that may or may not be the same series as defined by the first time sequence. The continuous sequence may be executed in a repeating fashion after the first time sequence has been completed. Other sequences may also be defined in the ad configuration. In notation form, these terms may be expressed as follows:

FTS=First Time Sequence

CS=Continuous Sequence

CT=Content Type

ET=Exposure Time

Configuration={Timestamp, FTS, CS}

FTS={(CT₁, ET₁), (CT₂, ET₂), . . . , (CTₘ, ETₘ)}

CS={(CT₁, ET₁), (CT₂, ET₂), . . . , (CTₙ, ETₙ)}

The client computer may retain the ad configuration and use the sequence information (first time, continuous, or other) to determine the specific ad content type to request from the server. The client computer may then send an ad request to the server that may contain its machine identification, a timestamp, and a content type. Upon reception of the content type from the server, the client computer may expose the content type for the duration specified by the corresponding paired exposure time in the ad configuration. The client computer may then use the next pair in the sequence to determine the next specified content type in the series and send a subsequent ad request to the server for that content type.

When the server receives an ad request from a client computer, it may record the ad request in an ad request history and may validate the request by comparing the content of the ad request against the ad configuration on record for the client computer. Since both the client computer and the server may be operating off of the same ad configuration and since the ad configuration is deterministic, the server may determine if the client computer is behaving in an expected manner, i.e., asking for the correct next content type after the correct amount of exposure time. If the ad request is valid, the server may obtain a legitimate ad content type and may send it to the client computer for it to expose. The legitimate ad content type delivery event may be then credited towards the owner account for compensation.

Fraud may be attempted when a malicious owner modifies client computers to request ads at a faster rate, thus attempting to increase the share of compensation associated with the owner's computers. Alternatively, a malicious user may try to falsely represent unregistered machines as legitimate or hack into the system in order to gain financial benefit. A fraud engine at the server may be responsible for detecting and mitigating potential fraud in the per-machine based owner compensation ad delivery system.

The fraud engine may have responsibility for detecting potentially fraudulent activity. It may be invoked by the process that receives the ad requests from the client computer, or it may run asynchronously to that process. The fraud engine may operate on an incoming, newly received ad request or it may traverse the list of ad requests retained in the request history or other data repository to operate on its entries. For a given ad request, the fraud engine may select from a library of fraud detection actions to use for detection. One example of a fraud detection action may be administrating a score for each client computer that may be decreased for each valid ad request and increased for each invalid ad request. If the score exceeds a predetermined score threshold, the fraud engine may initiate fraud mitigation for the suspicious client computer.

Another example of a fraud detection action may be validating the location of a client computer. If an ad request is received for a client computer expected to be located in Boston and the ad request comes from New York, the fraud engine may then initiate fraud mitigation. A third example may be validating the frequency of received ad requests. Using the ad request history, the entry on which the fraud engine is operating, and the expected ad configuration for the entry, the fraud engine may determine if ad requests are being received at a frequency greater than expected. If so, the fraud engine may initiate fraud mitigation. Other examples of fraud detection may include monitoring machine utilization and failed requests from invalid machines, and triggering fraud mitigation in each case upon surpassing a corresponding predetermined threshold.

Score threshold and other threshold levels associated with fraud detection may be set by another process or by administrative action, or they may be determined and adjusted in contextual real-time by the fraud engine itself. Of course, other fraud detection actions in addition to those already discussed may be possible and are not limited to the above examples.

The fraud engine may have responsibility for the fraud mitigation process. Fraud mitigation may or may not run asynchronously with the other processes previously discussed. The fraud engine may determine an appropriate selection of one or more fraud mitigation actions to be performed in response to the reception of a single suspicious ad request. It may also periodically traverse the request history, the machine list, and/or other retained data to collect an aggregate view of the behavior of a particular machine, and then select one or more fraud mitigation actions to be performed. Selection may be determined from a fixed algorithm, it may be tailored for seriousness and frequency of violations, or it may be based on real-time or a priori input from another entity such as the service provider, administrator, or another process. Fraud mitigation actions may include but are not limited to: flagging a machine to watch for a pattern over time; throttling requests where requests arriving after a prescribed timing window are allowed but those that arrive before a prescribed timing window are ignored; denial of all requests from a machine for a specific amount of time or denial forever; and returning an impotent ad content type where the ad content is delivered but the event is not credited to the owner account so that a malicious user will not be aware that his/her fraud has been detected. Of course, other fraud mitigation actions may be defined and used.

An interface to administer the fraud engine may also be employed. This interface may allow another process, an administrator, or some other party to adjust and add parameters used by the fraud engine, such as score thresholds, tolerance levels for triggering fraud mitigation actions upon fraud detection, timing windows, and the like. The interface may also allow addition, deletion, and modification to the set of fraud detection and fraud mitigation actions.

### DRAWINGS

FIG. 1 is a block diagram of a computing system that may operate in accordance with the claims;

FIG. 2 illustrates an exemplary architecture of a per-machine based owner compensation advertisement delivery system;

FIG. 3 illustrates an exemplary method of delivering ads in a per-machine based owner compensation advertisement delivery system, and detecting and mitigating fraud in said system;

FIG. 4a illustrates an exemplary ad configuration and FIG. 4b illustrates an exemplary ad request;

FIG. 5 details a process for enrolling a computer owner and his/her machines into a per-machine based owner compensation advertisement delivery system;

FIG. 6 details the method of validating an incoming ad request;

FIG. 7 illustrates a method of fraud detection in a per-machine based owner compensation advertisement delivery system;

FIGS. 7a, 7b, and 7c illustrate examples of fraud detection actions, respectively, the methods for administrating a score, location validation, and frequency validation; and

FIG. 8 illustrates a method of fraud mitigation in a per-machine based owner compensation advertisement delivery system.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

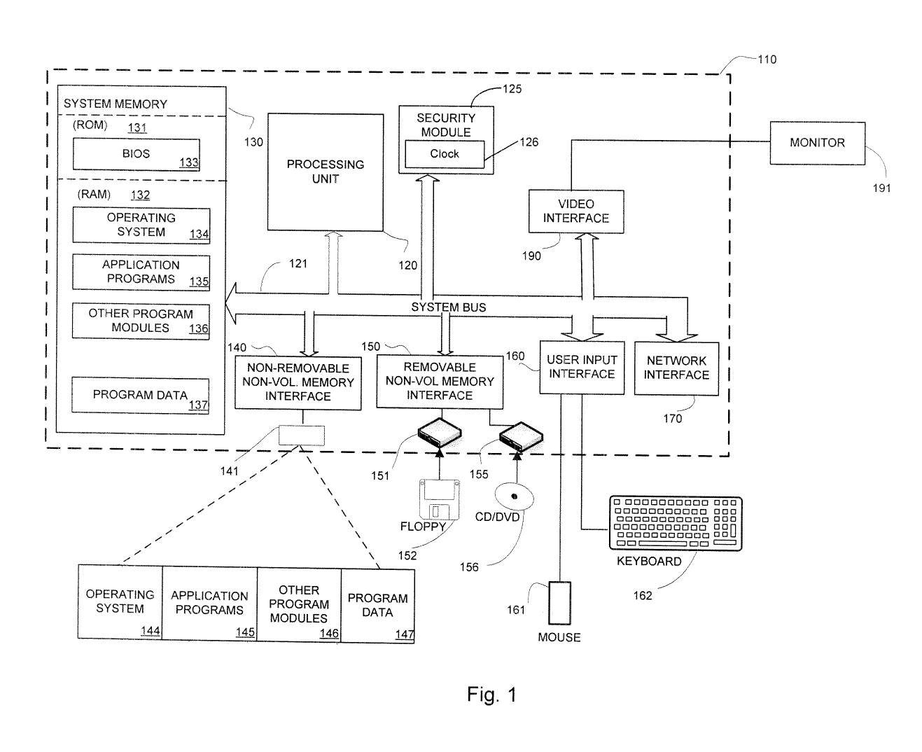

FIG. 1 illustrates a logical view of a computing device in the form of a computer 110 that may be used as a client computer or may be used as a server in a per-machine based owner compensation advertisement delivery system. For the sake of illustration, the computer 110 is used to illustrate the principles of the instant disclosure. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, front side bus, and Hypertransport™ bus, a variable width bus using a packet data protocol.

The computer 110 may include a security module 125. The security module 125 may be used for verifying the authenticity of received messages and for safe-guarding sent messages. The security module 125 may be embodied in the processing unit 120, as a standalone component, or in a hybrid, such as a multi-chip module. A clock 126 may be incorporated into the security module 125 to help ensure tamper resistance. To allow user management of local time setting, including daylight savings or movement between time zones, the clock 126 may maintain its time in a coordinated universal time (UTC) format and user time calculated using a user-settable offset. The security module 125 may also include a cryptographic function (not depicted).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, digital camera, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190.

The computer 110 may operate in a networked environment using logical connections to one or more remote computers (not depicted) over a network interface 170, such as broadband Ethernet connection or other known network.

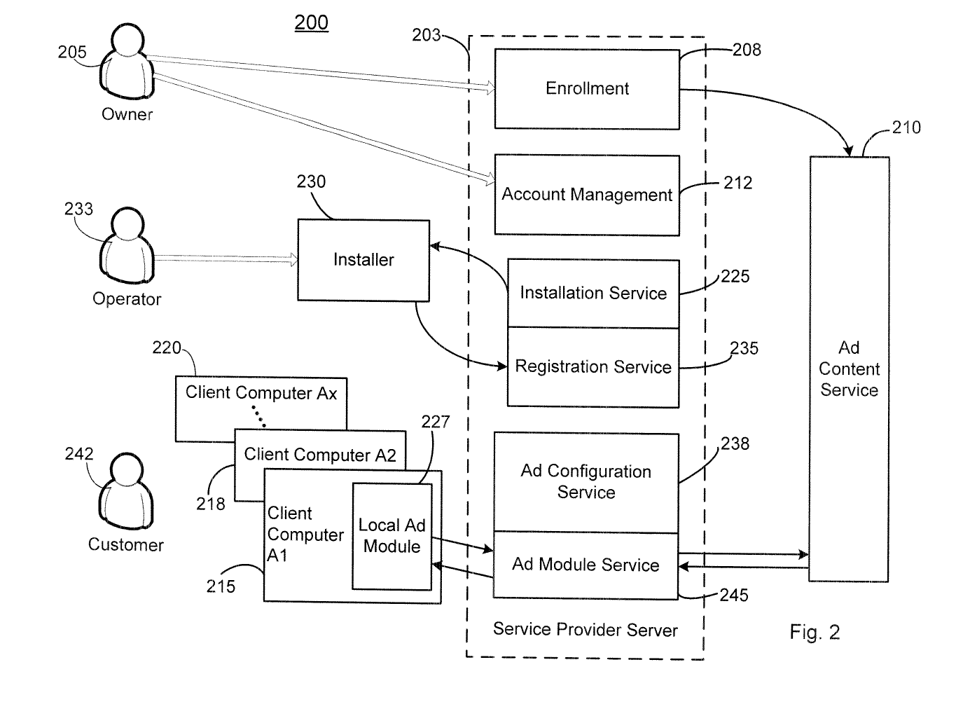

FIG. 2 illustrates an exemplary architectural embodiment of a per-machine based owner compensation ad delivery system 200. The service provider of the per-machine based owner compensation ad delivery may utilize a server 203 which may be of the form of the computer 110. When an owner 205 wishes to participate in per-machine based owner compensation ad delivery, the owner 205 may enroll 208 with the service provider. The owner enrollment may be accomplished via a website, mail-in application, phone call, or some other method. The owner enrollment 208 may inform an ad content service 210 about the parameters for advertising content and nature as specified by the owner 205 during owner enrollment 208. The ad content service 210 may have the responsibility of determining and/or targeting ad content and timing for the owner 205 or the customer 242. The ad content service 210 may reside on the same entity as the service provider server 203 or it may reside elsewhere, and may have the form of computer 110. In one embodiment, the ad content service 210 may be owned and operated by the same business entity as the service provider. In another embodiment, the ad content service 210 may be owned and operated by a third party entity.

Once the owner 205 is enrolled with the service provider, the server 203 may generate an owner account capable of being administered via an account management process 212. The owner account may be used to link one or more client computers 215 218 220 possessed by the owner 205 with the per-machine based owner compensation ad delivery system 200. The client computers 215 218 220 may have the form of computer 110. The server 203 may then invoke an installation service 225 to communicate a local ad module 227 to an installer 230 at a site specified by the owner 205. The communication mechanism may utilize a download from a website, installation of a program from a CD, or some other transfer mechanism. An operator 233 at the site who may be the owner 205 or may be another entity may administrate the installer 230 and distribute the local ad module 227 to the client computers 215 218 220. Administration of the installer 230 may register each client computer 215 218 220 with the registration service 235 and may result in associating each client computer 215 218 220 with the account of owner 205.

After registration 235 is completed, the server 203, with or without input from the ad content service 210, may invoke an ad configuration service 238 to designate an active ad configuration for the registered client computers 215 218 220. This active configuration may be delivered as a part of the registration service 235 or it may be delivered in response to an out-of-band request by the local ad module 227 at any time subsequent to successful completion of the registration service 235. Each client computer 215 218 220 of the owner 205 may receive the same ad configuration or they may receive different ad configurations. The ad configuration may be used by the local ad module 227 to administer the ad delivery on the client computer 215 218 220 for viewing by a customer 242 by defining sequences of content type and exposure time pairs. The local ad module 227 may use the specified content type in the active sequence specified by the active ad configuration to request a specific ad content type from the server 203. The local ad module 227 may use the corresponding exposure time as an indicator of how long to expose the ad content at the client computer 215 128 220.

An ad module service 245 at the server 203 may communicate with the local ad module 227 at the client computer 215 218 220. The ad module service 245 may receive and process ad requests from the local ad module 227, and may interface with the ad content service 210 to obtain appropriate ad content types for the client computer 215 218 220 based upon the input obtained from the owner 205 during enrollment 208 and/or machine registration 235. The ad content types may include but are not limited to contents (e.g., company names and products), mechanisms (e.g., pop-ups, browser bar banners, etc.), and behaviors (e.g., don't show ads during full-screen games, etc.). The ad module service 245 also may monitor incoming ad requests and request histories for fraud and may initiate fraud mitigation strategies.

As FIG. 2 illustrates, in a per-machine based owner compensation ad delivery system, the server 203 may have the responsibility for initializing and administering the framework for the owner 205 and his/her client computers 215, 218, 220. The server 203 also may serve as a communication channel to deliver advertising to the client computers 215, 218, 220 from the ad content service 210. The server 203 may have the responsibility to detect and mitigate potential fraudulent behavior of client computers 215, 218, 220. The various logical functions of the server 203 in FIG. 2 related to per-machine based owner compensation ad delivery (enrollment 208, account management 212, installation service 225, registration service 235, ad configuration service 238, and ad module service 245) may illustrate one exemplary embodiment of division of functionality at the service provider. Other divisions of labor may be possible. For example, in one embodiment, the enrollment function 208 may be performed by one physical server while the installation service function 225 and other communication functions with client computers 215 218 220 may be performed by a different physical server. In another embodiment, the functions of account management 212, ad configuration service 238, and ad module service 245 may be performed by the same logical entity or process within the server 203, and the other functions may be performed by several other distinct logical entities. Other different architectural configurations are possible. Additionally, other per-machine based owner compensation ad delivery functions may be possible beyond those illustrated by FIG. 2.

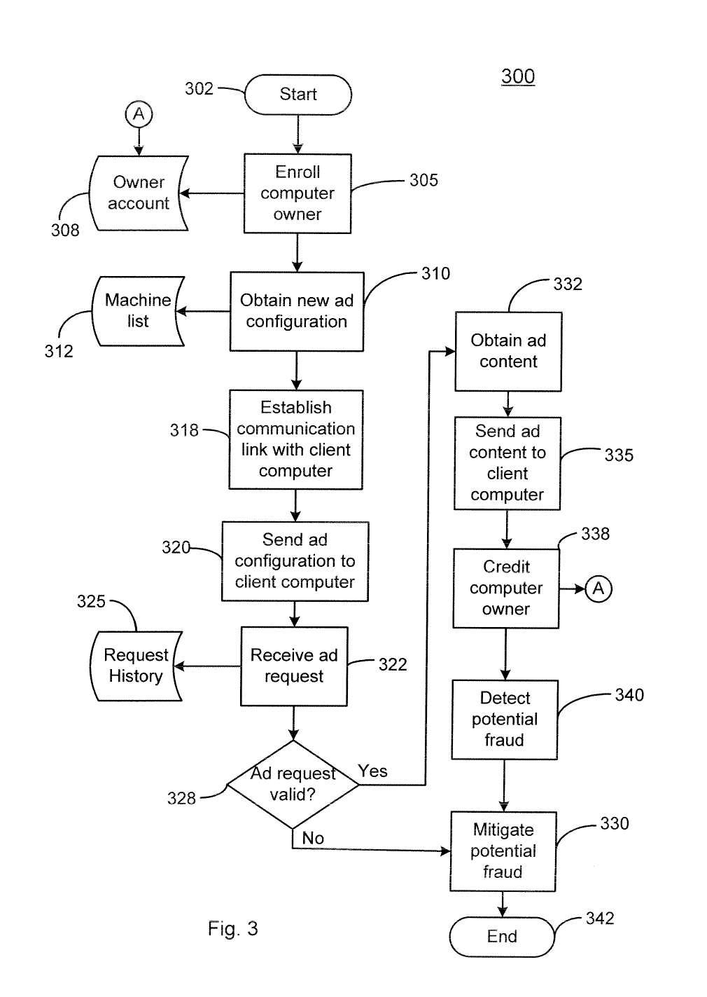

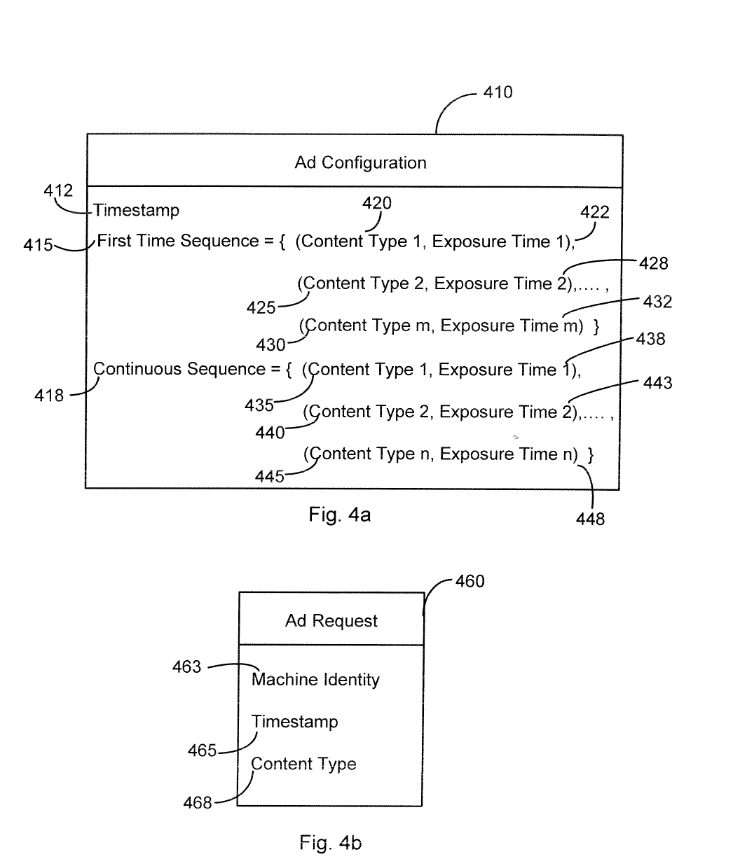

FIG. 3 illustrates an exemplary method 300 of per-machine based owner compensation ad delivery, detecting fraud, and mitigating fraud. At the start 302, a server of the ad delivery service provider such as server 203 of FIG. 2 may enroll 305 the computer owner with the ad delivery service provider by creating an owner account 308. For a client computer of the owner such as client computer A1 215 of FIG. 2, an ad configuration may be obtained 310. (An exemplary ad configuration is shown in FIG. 4a.) The client computer may be assigned a machine identity number and placed onto a machine list 312 along with other parameters needed to perform per-machine based owner compensation such as but not limited to expected location and expected ad configuration. Next, communications may be established 318 between the server of the service provider and the client computer using HTTP, HTTPS, or some other known protocol in the art over a wireless, broadband, direct connection, or some other standard networking connection. The ad configuration may then be sent 320 to the client computer.

Next, an ad request may be received 322 from the client computer. (An exemplary ad request is shown by FIG. 4b.) The received ad request may be stored in a request history 325 and checked for validity 328. If it is found to be invalid, the method may invoke mitigation of potential fraud 330, which is described in more detail in a subsequent section. If the ad request is found to be valid, the ad content type specified in the ad request message is obtained 332 and sent 335 to the client computer. The owner account 308 may then be credited 338 for compensation associated with the event of the legitimate ad content type being sent to the specific client computer. Potential fraud detection 340 and potential fraud mitigation 330 may be performed synchronously with this thread of logic or may be performed asynchronously. (These processes 340 330 are described in more detail in following sections.) Finally, the method may end 342.

If the owner possesses other client computers such as client computers A2 218 through Ax 220 of FIG. 2 that s/he wishes to use in the per-machine based owner compensation ad delivery system, the same process 300 may be followed for those machines. This may result in client computers A2 218 through Ax 220 being associated with the owner in owner account 308, added to the machine list 312, and sent ad configurations 320. The ad configurations for client computers A2 218 through Ax 220 may be the same ad configuration or may be different ad configurations. Every legitimate ad content type sent to each client computer A2 218 through Ax 220 may result in crediting 338 the owner account 308 corresponding to the event and the specific client computer.

FIG. 4a illustrates an exemplary ad configuration 410 that may be sent to the client computer and may be stored, along with a linkage to its associated client computer, at the server as an entry, for instance, in a machine list such as 312 of FIG. 3. The ad configuration 410 may contain a timestamp 412 of delivery, a first time sequence 415 to be displayed initially, and a continuous sequence 418 to be displayed in a continual loop. The first time sequence 415 may define a series of expected content type and exposure time pairs for the client computer to use in requesting and displaying advertisements. For instance, in ad configuration 410, content type 1 420 may be expected to be contained in the first ad request and expected to be exposed at the client computer for a duration of exposure time 1 422. Next, the client computer may be expected to request content type 2 425 from the server, and expose it for a duration of exposure time 2 428. The remainder of the first time sequence may be followed, ending with requesting and displaying content type m 430 for a duration of exposure time m 432. After the first time sequence 415 has been completed, the continuous sequence 418 may be expected to be followed, by requesting content type 1 435 and exposing it for a duration of exposure time 1 438, content type 2 440 for exposure time 2 443, and so on through the series. After requesting content type n 445 and exposing it for a duration of exposure time n 448, content type 1 435 may be requested to continue looping through the continuous sequence 418. The sets of content types and exposure time pairs defined by the first time sequence 415 may or may not be the same as the set of pairs defined by the continuous sequence 418.

FIG. 4b illustrates an exemplary ad request 460 that may be sent from the client computer or may be stored at the server as an entry in a request history such as in 325 of FIG. 3. The ad request 460 may contain the machine identity 463 of the client computer, a timestamp 465 of delivery, and an ad content type 468.

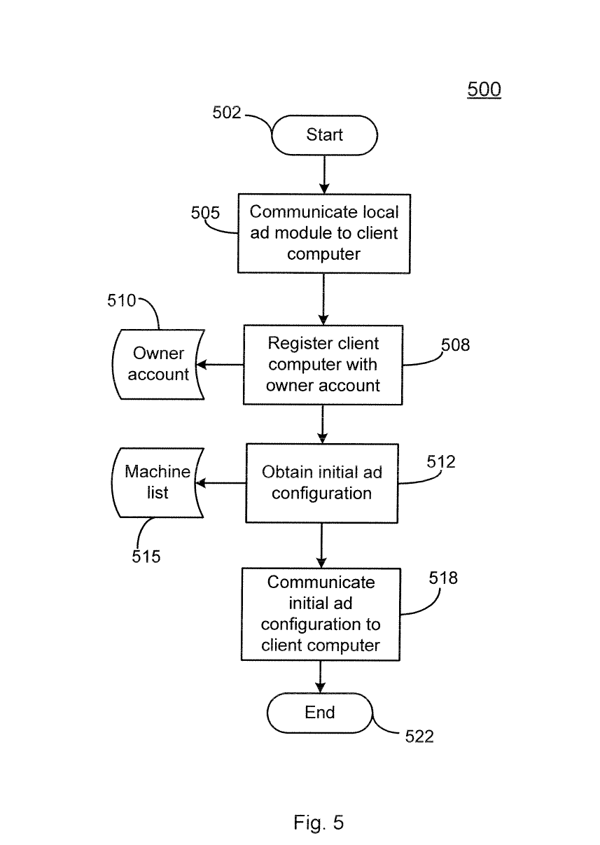

FIG. 5 illustrates an embodiment of an enrollment process 500, such as 305 of FIG. 3. At the start 502, a local ad module may be communicated 505 to the client computer to configure it for use in the ad delivery system. The client computer may be registered 508 with the owner account 510. An initial ad configuration may be obtained 512 and stored with the client computer's machine identity in the machine list 515. The initial ad configuration may then be sent 518 to the client computer. The enrollment process 500 may then end 522. This enrollment process 500 may be executed for each client computer that an owner wishes to use in a per-machine based owner compensation agreement with the ad delivery service provider.

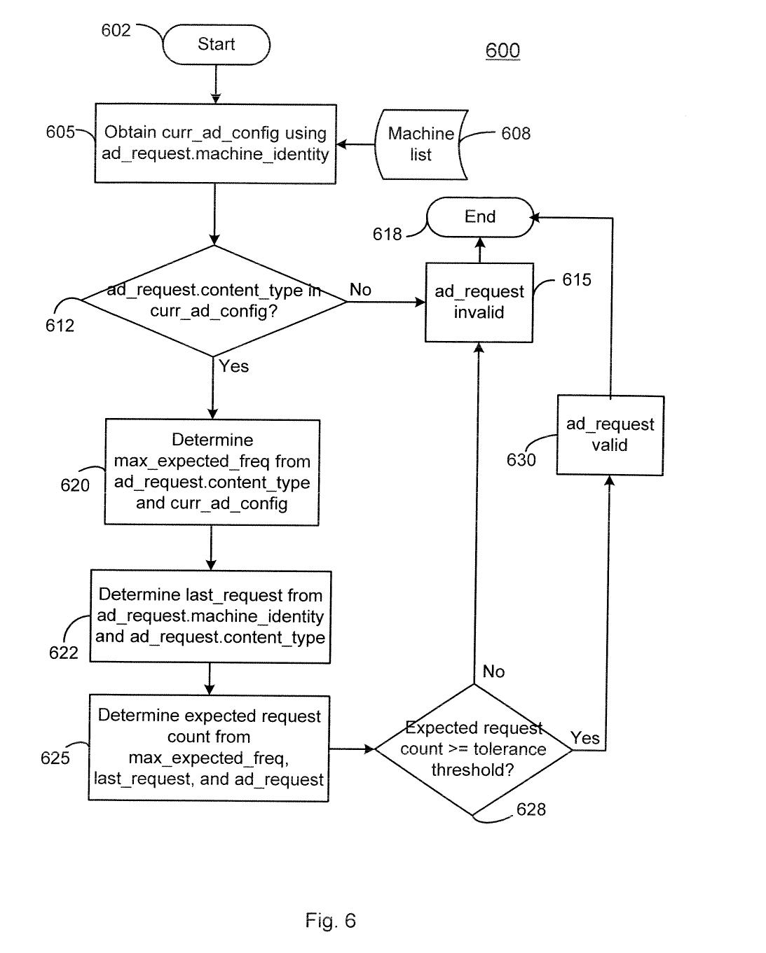

FIG. 6 illustrates an embodiment of a validation process 600, such as 328 of FIG. 3. At the start 602, an ad request such as 460 of FIG. 4b may have been received from a client computer. The request machine identity 463 of the ad request 460 may be used along with input from the machine list 608 to find a current stored ad configuration. The current ad configuration may be in a format such as 410 of FIG. 4a. Next, the ad request content type 468 may be checked 612 to see if it is found in the set of content types of the current ad configuration. If not, the ad request 460 may be found to be invalid 615 and the process may end 618.

If the content type is found in the current ad configuration, a maximum expected frequency may be determined 620 from the content type of the ad request 468 and the current ad configuration 410. The last request sent may be determined 622 from the machine identity of the ad request 463 and the content type of the ad request 468. Then, the expected request count may be determined 625 based upon the maximum expected frequency, the last request, and the ad request 460. The expected request count may be compared 628 to a tolerance threshold. If the expected request count is greater than or equal to a tolerance threshold, this may signify that the client computer is behaving in an expected manner as defined by the stored ad configuration 410, i.e., sending expected ad requests for an expected content type at an expected rate. The ad request 460 may be found to be valid 630, and the process may end 618. If the expected request count is less than a tolerance threshold, the ad request may be found to be invalid 615. The process may end 618 and return to 300 for potential fraud mitigation 330. The tolerance threshold may be set at the same level for each client computer, or may be set based on another grouping such as but not limited to an owner, a location, or a group of computers. The tolerance threshold may also be capable of being administered by another process, an administrator of the service provider, or some other entity.

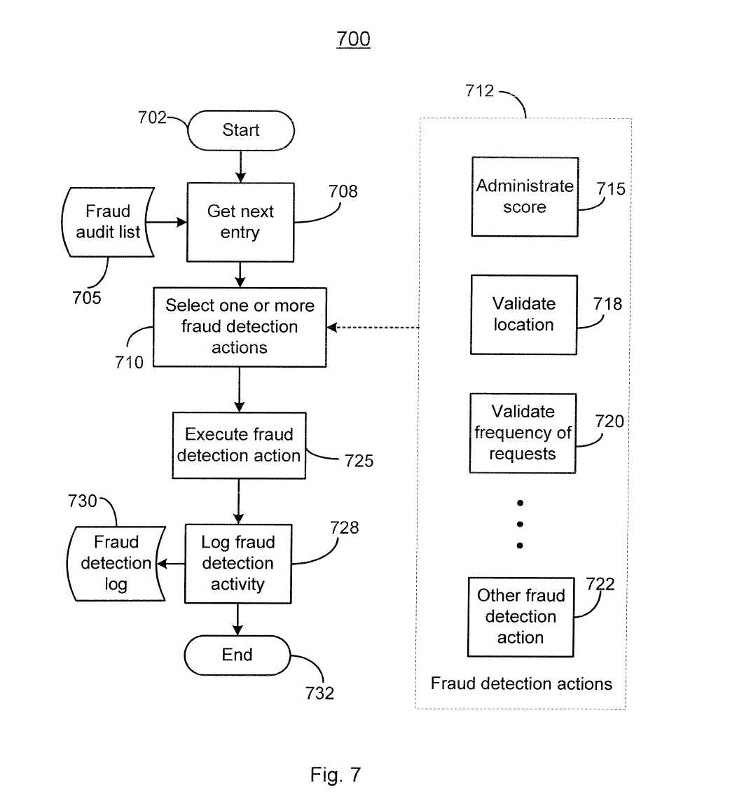

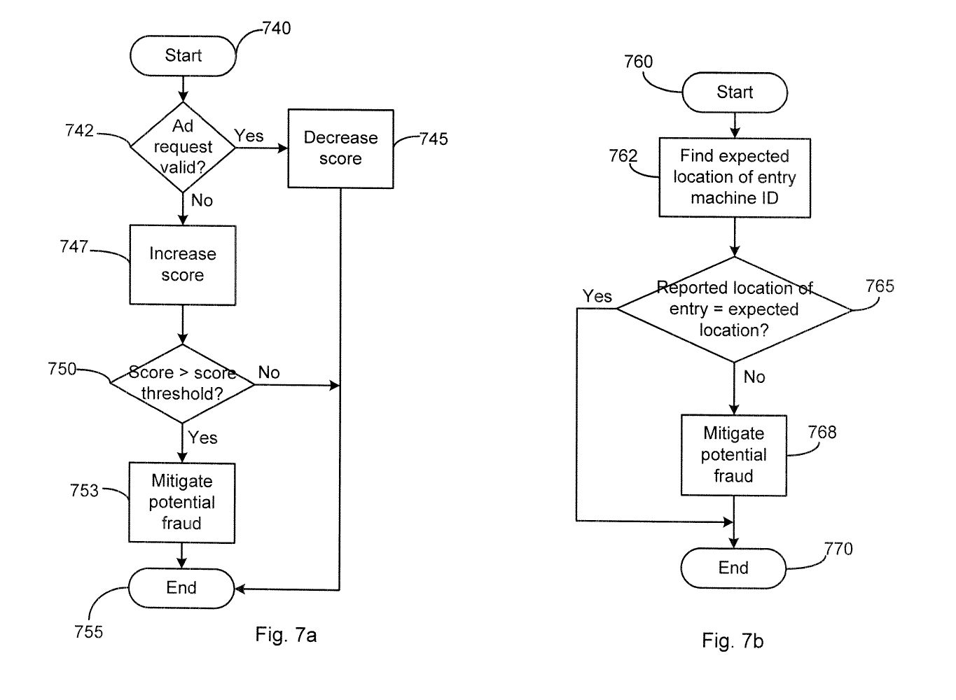

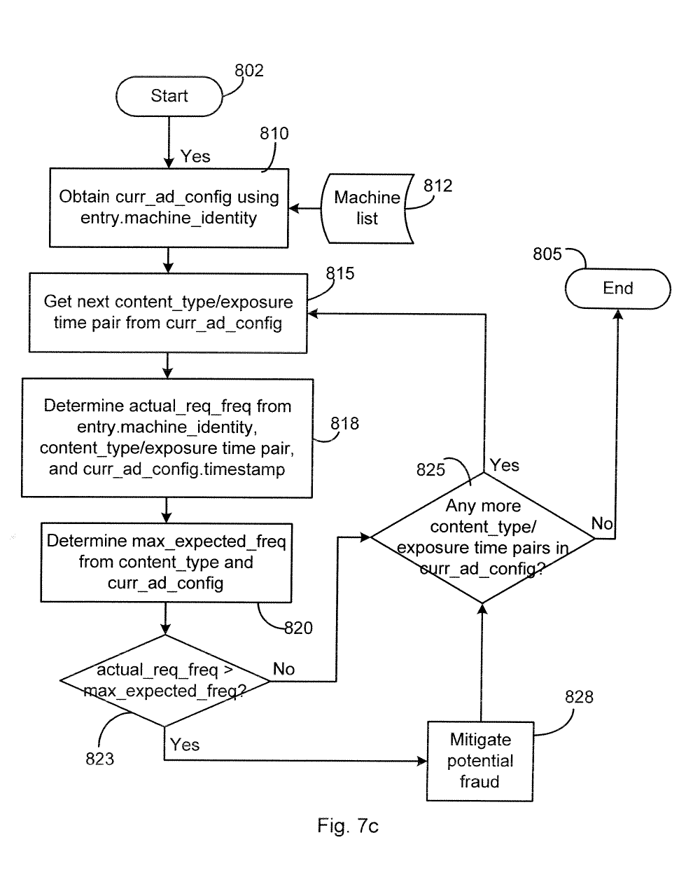

FIG. 7 illustrates an embodiment of a fraud detection process 700 such as 340 of FIG. 3. At the start 702, this process 700 may operate on an incoming received ad request such as 460 of FIG. 4b, or it may traverse a fraud audit list 705 to get an entry on which to operate. The fraud audit list 705 may be the request history, the machine list, or may be some other repository of stored information used in a per-machine owner compensation based system. The process 700 may get an entry 708 off of the fraud audit list 705 and select 710 one or more fraud detection actions 712 to execute. Examples of fraud detection actions may be administrating a score 715 for a client computer, validating the location 718 of a client computer, validating frequency of requests 720 from a client computer, or any number of other fraud detection actions 722. Adding to, deleting from, and modifying the set of fraud detection actions 712 may be enabled by another process, an administrator, or some other means through an interface. The selected fraud detection action(s) may be executed 725 and recorded 728 in a fraud detection log 730, and then the process may end 732.

The fraud detection action of administrating a score 715 for a client computer is illustrated in more detail by FIG. 7a. At the start 740, an incoming ad request may be validated 742. If the ad request is found to be valid, the corresponding score for the client computer may be decreased 745. If the ad request is found to be invalid, the score may be increased 747. The score may be compared against a score threshold 750 and if it exceeds the score threshold, the process of mitigating potential fraud may be invoked 753 and score administration may end 755. The score threshold may be set at the same level for each client computer, or may be set based on another grouping such as but not limited to an owner, a location, or a group of computers. The score threshold may also be capable of being administered by another process, an administrator of the service provider, or some other entity. Thus, the score may be used as a configurable tolerance mechanism for detecting potential fraud.

The fraud detection action of validating a client computer's location 718 is illustrated in more detail by FIG. 7b. At the start 760, the expected location of the entry 708 may be found 762 by searching the machine list 312, owner account 308, or some other record. The expected location may then be compared against the reported location 765 of the entry. If the locations do not match, the process of mitigating potential fraud 768 may be invoked and location validation may end 770.

FIG. 7c illustrates in more detail the fraud detection action of validating the frequency of requests 720 for a client computer. At the start 802, using the machine identity of the client computer, the current ad configuration may be obtained 810 from the machine list 812. The current ad configuration may be of the form 410 of FIG. 4a. The process then may traverse the content types 420 425 430 435 440 445 in the sequences 415 418 of the current ad configuration 410. For each content type 815, the actual request frequency may be determined 818 from the machine identity of the entry 708, the corresponding content type/exposure time pair in a sequence 415 418 of the current ad configuration 410, and the timestamp 412 of the current ad configuration. The maximum expected frequency may be determined 820 from the content type and the current ad configuration 410. The actual request frequency may then be compared against the maximum expected frequency 823, and if it is less than the maximum expected frequency, this may signify that the client computer may be behaving in an expected manner, and the frequency validation process may move on to the next content type/exposure time pair 825. If the actual request frequency is found to be greater than the maximum expected frequency, potential fraud may be detected and a fraud mitigation process 828 may be invoked. The frequency validation process then may continue on to assess the next content type/exposure time pair 825. When all of the pairs have been exhausted, the process may end 805.

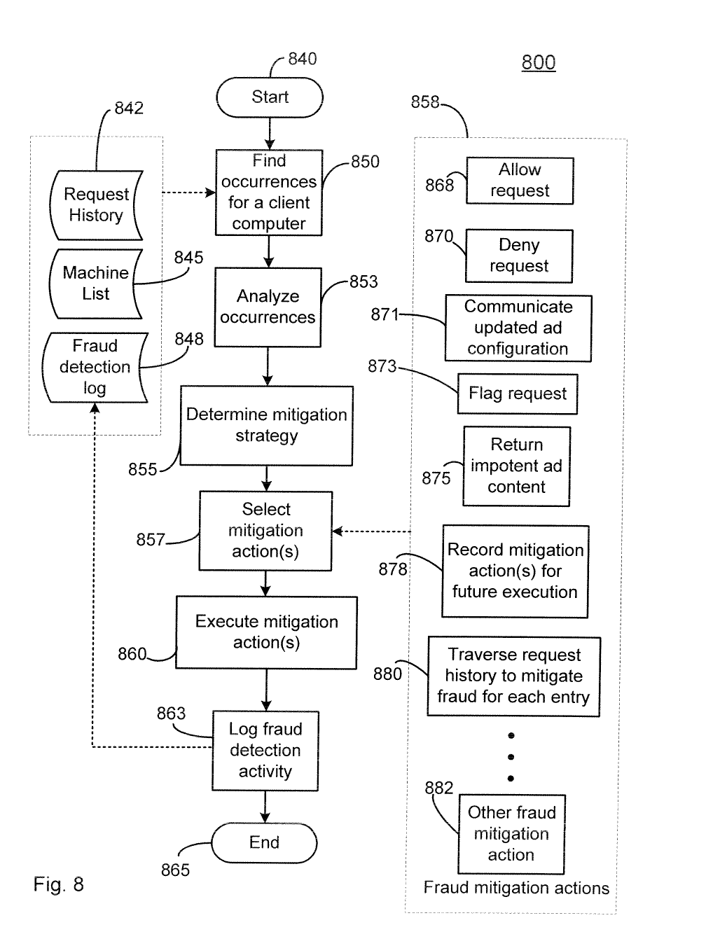

FIG. 8 illustrates an embodiment of a fraud mitigation process 800, such as 330 of FIG. 3. At the start 840, the process 800 may use the request history 842, the machine list 845, and/or the fraud detection log 848 to find 850 occurrences associated with the specific machine identity of a client computer. Other records of per-machine based owner compensation may also be examined. These occurrences may be analyzed 853 to determine 855 a fraud mitigation strategy. The strategy may consist of a selection from a set of fraud mitigation actions 858 to be performed at an appropriate time and sequence to support the determined mitigation strategy 855. The selected mitigation action(s) may be executed 860 immediately or may be scheduled to be executed, they may be logged 863 in the fraud detection log 848, and the process may end 865.

The set of fraud mitigation actions 858 may include options such as but not limited to allowing the request 868, denying the request 870, communicating an updated ad configuration to the client computer 871, and flagging the request as suspicious or to be examined more closely 873. Another fraud mitigation action of the set 858 may consist of returning an impotent ad content 875 where the ad content looks legitimate but does not cause the owner account to be credited, thus concealing from the malicious user the fact that potential fraud may have been detected at the server. Any of these mitigation actions may be recorded/delayed for future execution 878, or a complete traversing of the request history 880 may be performed for each machine identity. Other fraud mitigation actions 882 may be possible. Adding to, deleting from, and modifying the set of fraud mitigation actions 858 may be enabled by another process, an administrator, or some other means through an interface.

The set of fraud mitigation actions 858 may also be added to, deleted from or modified by another process, an administrator, or by some other means through an interface. Also, any parameters, thresholds, and the like associated with configuring execution of the mitigation actions 858 may also be added to, deleted from or modified by another process, an administrator, or by some other means through an interface. For instance, when a per-machine based owner compensation ad delivery system is initially configured and installed, the service provider may want to enable the variable parameters to be modified for aid in determining an acceptable level of tolerance in that particular owner's set-up. One fraud mitigation strategy may be to allow invalid ad requests up to a certain level or time or frequency, and to return impotent ad contents or deny all requests after that point. Another strategy may be to flag a machine so that requests coming faster than a predetermined rate are dropped, and every fifth (or some other changeable parameter) ad request is allowed. Many other different fraud mitigation strategies may be configured by method 800 depending on the combination of actions selected and when and in what sequence the actions are scheduled to be performed according to the determined fraud mitigation strategy 855.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. In a machine-based ad delivery system, a method of compensating a computer owner on a per-machine basis, detecting potential fraud, and mitigating potential fraud at a server of an ad delivery service provider comprising:
(a) enrolling the computer owner with the ad delivery service provider, comprising creating an owner account comprising creating a record, the record comprising an identification of a client computer of the computer owner and a location of the client computer;
(b) obtaining a new ad configuration, the new ad configuration comprising a new timestamp, a new first time sequence comprising a first set of one or more content type and exposure time pairs, and a new continuous sequence comprising a second set of one or more content type and exposure time pairs;
(c) storing a client machine identity of the client computer on a machine list and associating the client machine identity with the new ad configuration;
(d) establishing a communication link with the client computer;
(e) communicating the new ad configuration to the client computer;
(f) receiving an ad request from the client computer comprising:
i) receiving an ad request message, the ad request message comprising a request machine identity, a request timestamp, and a request content type;
ii) storing the ad request message in a request history;
iii) validating the ad request message;
iv) if the ad request message is found to be valid:
retrieving a legitimate ad content corresponding to the request content type,
communicating the legitimate ad content to the client computer, and
crediting the computer owner, comprising correlating the legitimate ad content to the record; and
v) if the ad request message is found to be invalid, mitigating potential fraud;
(g) detecting potential fraud; and
(h) mitigating potential fraud.

2. The method of claim 1, wherein enrolling the computer owner with the ad delivery service provider further comprises:
(a) communicating a local ad module to the client computer, comprising at least one of the group comprising downloading the local ad module and transferring the local ad module;
(b) registering the client computer with the owner account, comprising retaining the client machine identity;
(c) obtaining an initial ad configuration comprising an initial timestamp, an initial first time sequence comprising a third set of one or more content type and exposure time pairs, and an initial continuous sequence comprising a fourth set of one or more content type and exposure time pairs;
(d) storing the initial ad configuration corresponding to the client machine identity; and
(e) communicating the initial ad configuration to the client computer.

3. The method of claim 1, wherein validating the ad request message comprises:
(a) obtaining a found ad configuration corresponding to the request machine identity, the found ad configuration comprising a found timestamp, a found first time sequence comprising a fifth set of one or more content type and exposure time pairs, and a found continuous sequence comprising a sixth set of one or more content type and exposure time pairs;
(b) searching for the request content type in the fifth and sixth sets of the found ad configuration;
(c) identifying the ad request message as invalid and ending validating the ad request message if the request content type is not found in the fifth and sixth sets;
(d) determining an expected request count, comprising:
determining a maximum expected frequency from the request content type and the found ad configuration,
determining a last request from the request machine identity and the request content type, and
using the maximum expected frequency, the last request, and the ad request message to determine the expected request count;
(e) identifying the ad request message as valid if the expected request count is determined to be above a tolerance threshold; and
(f) identifying the ad request message as invalid if the expected request count is determined to be equivalent to or below the tolerance threshold.

4. The method of claim 3, further comprising enabling an interface for selecting the tolerance threshold, wherein the tolerance threshold corresponds to at least one of the group comprising: the computer owner, the owner account, the location of the client computer, one or more client computers of the computer owner, one or more ad delivery configurations, and the machine-based ad delivery system.

5. The method of claim 1, wherein detecting potential fraud comprises enabling a fraud engine comprising traversing a fraud audit list, the fraud audit list comprising at least one of the request history and the machine list, and for each entry of the fraud audit list, selecting at least one from a group of fraud detection actions comprising:
a) administrating a score corresponding to an entry machine identity corresponding to the entry comprising:
decreasing the score when a valid ad request is received,
increasing the score when an invalid ad request is received, and
mitigating potential fraud if the score rises above a score threshold; further comprising enabling an interface for administrating the score;
b) location validating, comprising determining if a reported location of a first computer corresponding to the entry machine identity is equivalent to an expected location of the first computer and mitigating potential fraud if the reported location is nonequivalent to the expected location;
c) frequency validating, comprising for an entry of the fraud audit list:
obtaining a current ad configuration corresponding to the entry machine identity, the current ad configuration comprising a current timestamp, a current first time sequence comprising a seventh set of one or more content type and exposure time pairs, and a current continuous sequence comprising an eighth set of one or more content type and exposure time pairs; and
obtaining a current content type list from the current ad configuration, and for each individual content type on the current content type list:
i) determining an actual request frequency based on the entry machine identity, the individual content type and exposure time pair, and the current timestamp,
ii) determining a maximum expected frequency based on the individual content type and the current ad configuration, and
iii) mitigating potential fraud if the actual request frequency is greater than the maximum expected frequency;
d) executing the one or more selected fraud detection actions;
e) logging in the fraud detection log at least one of the group comprising the entry, the one or more executed fraud detection actions, and a fraud detection action timestamp; and
f) enabling an interface for administrating the fraud engine comprising adding to, deleting from, and modifying the group of fraud detection actions.

6. The method of claim 1, wherein mitigating potential fraud comprises enabling the fraud engine to initiate one or more fraud mitigation actions for a candidate request, the candidate request comprising a candidate request machine identity, a candidate request timestamp, and a candidate request content type,
enabling the fraud engine comprising:
finding one or more occurrences corresponding to the candidate request machine identity in at least one of a group comprising the request history, the machine list, and the fraud detection log;
analyzing the one or more occurrences to determine a mitigation strategy, comprising selecting one or more fraud mitigation actions from a group comprising:
(a) allowing the candidate request,
(b) denying the candidate request,
(c) communicating an updated ad configuration;
(d) flagging the candidate request as potentially fraudulent,
(e) retrieving an impotent ad content corresponding to the candidate request content type and communicating the impotent ad content to a candidate computer corresponding to the candidate request machine identity, wherein the impotent ad content is uncorrelated to compensating the computer owner of the candidate computer,
(f) recording one or more fraud mitigation actions for execution after a future event occurs, the future event comprising one of a group comprising: receiving a subsequent ad request corresponding to the candidate request machine identity and exceeding a configurable threshold,
(g) traversing the request history, and for each request history entry, performing one or more of the fraud mitigation actions (a) through (f);
executing the one or more selected fraud mitigation actions; and
logging in the fraud detection log at least one of the group comprising the candidate request, the one or more selected fraud mitigation actions, and a fraud mitigation action timestamp.

7. The method of claim 6, further comprising enabling an interface for administrating the fraud engine, comprising: adding to, deleting from, and modifying the group of fraud mitigation actions and adding to and modifying a set of parameters for use by the fraud engine in determining the mitigation strategy,
wherein determining the mitigation strategy further comprises determining an execution sequence and a timing of selected mitigation actions based upon the set of parameters, and wherein the set of parameters comprises the configurable threshold.

8. The method of claim 1, further comprising performing steps of the method by more than one server of the ad delivery service provider.

9. The method of claim 1, wherein creating an owner account further comprises creating one or more records, each record corresponding to a different client computer of the computer owner.

10. A method of detecting and mitigating potentially fraudulent ad requests in a per-machine based owner compensation ad delivery system, the system comprising a computer owner, a service provider of per-machine based owner compensation ad delivery, one or more client computers of the computer owner adapted for operation in a per-machine based owner compensation ad delivery system, and a server of the service provider, the method comprising at the server:
a) maintaining a request history comprising one or more received ad requests, each received ad request comprising a request machine identity, a request timestamp, and a request content type;
b) maintaining a machine list comprising a client machine identity for each client computer, and associating the client machine identity with an ad delivery configuration comprising an ad configuration timestamp, an ad configuration first time sequence comprising a first set of one or more content type and exposure time pairs, and an ad configuration continuous sequence comprising a second set of one or more content type and exposure time pairs;
c) traversing a fraud audit list, the fraud audit list comprising at least one of the request history and the machine list, and for each entry of the fraud audit list, selecting, executing, and logging in a fraud detection log at least one from a group of fraud detection actions;
d) initiating one or more fraud mitigation actions for a candidate request, the candidate request comprising one of the group comprising a new ad request and an entry of the fraud audit list, and further comprising a candidate request machine identity, a candidate request timestamp, and a candidate request content type;
e) enabling an interface for administering the fraud engine, wherein administering the fraud engine comprises at least one of the group comprising: adding to, deleting from, and modifying the group of fraud detection actions; adding to, deleting from, and modifying the group of fraud mitigation actions; and
adding to and modifying a set of threshold parameters for use by the fraud engine in determining a mitigation strategy, wherein determining the mitigation strategy comprises selecting one or more fraud mitigation actions and determining an execution sequence and a timing of said mitigation actions;
f) allowing per-machine based owner compensation for a received ad request that is determined to be valid, comprising crediting an owner account for the received ad request; and
g) denying per-machine based owner compensation for a received ad request that is determined to be invalid.

11. The method of claim 10, wherein the group of fraud detection actions comprises:
a) administrating a score corresponding to an entry machine identity corresponding to the entry comprising:
decreasing the score when a valid ad request is received,
increasing the score when an invalid ad request is received, and
mitigating potential fraud if the score rises above a score threshold; further comprising enabling an interface for administrating the score;
b) location validating, comprising determining if a reported location of a first computer corresponding to the entry machine identity is equivalent to an expected location of the first computer and mitigating potential fraud if the reported location is nonequivalent to the expected location;
c) frequency validating, comprising for an entry of the fraud audit list:
obtaining a current ad configuration corresponding to the entry machine identity, the current ad configuration comprising a current timestamp, a current first time sequence comprising a second set of one or more content type and exposure time pairs, and a current continuous sequence comprising an third set of one or more content type and exposure time pairs; and
obtaining a current content type list from the current ad configuration, and for each individual content type on the current content type list:
i) determining an actual request frequency based on the entry machine identity, the individual content type and exposure time pair, and the current timestamp,
ii) determining a maximum expected frequency based on the individual content type and the current ad configuration, and
iii) mitigating potential fraud if the actual request frequency is greater than the maximum expected frequency;

12. The method of claim 10, wherein initiating one or more fraud mitigation actions for a candidate request comprises:
finding one or more occurrences corresponding to the candidate request machine identity in at least one of a group comprising the request history, the machine list, and the fraud detection log;
analyzing the one or more occurrences to determine a mitigation strategy, comprising selecting one or more fraud mitigation actions from a group comprising:
(a) allowing the candidate request,
(b) denying the candidate request,
(c) communicating an updated ad configuration;
(d) flagging the candidate request as potentially fraudulent,
(e) retrieving an impotent ad content corresponding to the candidate request content type and communicating the impotent ad content to a candidate computer corresponding to the candidate request machine identity, wherein the impotent ad content is uncorrelated to compensating the computer owner of the candidate computer,
(f) recording one or more fraud mitigation actions for execution after a future event occurs, the future event comprising one of a group comprising: receiving a subsequent ad request corresponding to the candidate request machine identity and exceeding a configurable threshold,
(g) traversing the request history, and for each request history entry, performing one or more of the fraud mitigation actions (a) through (f);
executing the one or more selected fraud mitigation actions; and
logging in the fraud detection log at least one of the group comprising the candidate request, the one or more selected fraud mitigation actions, and a fraud mitigation action timestamp.

13. A computer-readable storage medium tangibly embodying a program of instruction executable by a computer for performing steps compensating a computer owner on a per-machine basis, detecting potential fraud, and mitigating potentially fraud comprising at a server of an ad delivery service provider:
(a) enrolling the computer owner with the ad delivery service provider, comprising creating an owner account comprising creating a record, the record comprising an identification of a client computer of the computer owner and a location of the client computer;
(b) obtaining a new ad configuration, the new ad configuration comprising a new timestamp, a new first time sequence comprising a first set of one or more content type and exposure time pairs, and a new continuous sequence comprising a second set of one or more content type and exposure time pairs;
(c) storing a client machine identity of the client computer on a machine list and associating the client machine identity with the new ad configuration;
(d) establishing a communication link with the client computer;
(e) communicating the new ad configuration to the client computer;
(f) receiving an ad request from the client computer comprising:
i) receiving an ad request message, the ad request message comprising a request machine identity, a request timestamp, and a request content type;
ii) storing the ad request message in a request history;
iii) validating the ad request message;
iv) if the ad request message is found to be valid:
retrieving a legitimate ad content corresponding to the request content type,
communicating the legitimate ad content to the client computer, and
crediting the computer owner, comprising correlating the legitimate ad content to the record; and
v) if the ad request message is found to be invalid, mitigating potential fraud;
(g) detecting potential fraud; and
(h) mitigating potential fraud.

14. The computer-readable storage medium of claim 13, wherein enrolling the computer owner with the ad delivery service provider further comprises:
(a) communicating a local ad module to the client computer, comprising at least one of the group comprising downloading the local ad module and transferring the local ad module;
(b) registering the client computer with the owner account, comprising retaining the client machine identity;
(c) obtaining an initial ad configuration comprising an initial timestamp, an initial first time sequence comprising a third set of one or more content type and exposure time pairs, and an initial continuous sequence comprising a fourth set of one or more content type and exposure time pairs;
(d) storing the initial ad configuration corresponding to the client machine identity; and
(d) communicating the initial ad configuration to the client computer.

15. The computer-readable storage medium of claim 13, wherein validating the ad request message comprises:
(a) obtaining a found ad configuration corresponding to the request machine identity, the found ad configuration comprising a found timestamp, a found first time sequence comprising a fifth set of one or more content type and exposure time pairs, and a found continuous sequence comprising a sixth set of one or more content type and exposure time pairs;
(b) searching for the request content type in the fifth and sixth sets of the found ad configuration;
(c) identifying the ad request message as invalid and ending validating the ad request message if the request content type is not found in the fifth and sixth sets;
(d) determining an expected request count, comprising:
determining a maximum expected frequency from the request content type and the found ad configuration,
determining a last request from the request machine identity and the request content type, and
using the maximum expected frequency, the last request, and the ad request message to determine the expected request count;
(e) identifying the ad request message as valid if the expected request count is determined to be above a tolerance threshold; and
(f) identifying the ad request message as invalid if the expected request count is determined to be equivalent to or below the tolerance threshold.

16. The computer-readable storage medium of claim 13, further comprising enabling an interface for selecting the tolerance threshold, wherein the tolerance threshold corresponds to at least one of the group comprising: the computer owner, the owner account, the location of the client computer, one or more client computers of the computer owner, one or more ad delivery configurations, and the machine-based ad delivery system.

17. The computer-readable storage medium of claim 13, wherein detecting potential fraud comprises enabling a fraud engine comprising traversing a fraud audit list, the fraud audit list comprising at least one of the request history and the machine list, and for each entry of the fraud audit list, selecting at least one from a group of fraud detection actions comprising:
a) administrating a score corresponding to an entry machine identity corresponding to the entry comprising:
decreasing the score when a valid ad request is received,
increasing the score when an invalid ad request is received, and
mitigating potential fraud if the score rises above a score threshold; further comprising enabling an interface for administrating the score;
b) location validating, comprising determining if a reported location of a first computer corresponding to the entry machine identity is equivalent to an expected location of the first computer and mitigating potential fraud if the reported location is nonequivalent to the expected location;
c) frequency validating, comprising for an entry of the fraud audit list:
obtaining a current ad configuration corresponding to the entry machine identity, the current ad configuration comprising a current timestamp, a current first time sequence comprising a seventh set of one or more content type and exposure time pairs, and a current continuous sequence comprising an eighth set of one or more content type and exposure time pairs; and
obtaining a current content type list from the current ad configuration, and for each individual content type on the current content type list:
i) determining an actual request frequency based on the entry machine identity, the individual content type and exposure time pair, and the current timestamp,
ii) determining a maximum expected frequency based on the individual content type and the current ad configuration, and
iii) mitigating potential fraud if the actual request frequency is greater than the maximum expected frequency;
d) executing the one or more selected fraud detection actions;
e) logging in the fraud detection log at least one of the group comprising the entry, the one or more executed fraud detection actions, and a fraud detection action timestamp; and
f) enabling an interface for administrating the fraud engine comprising adding to, deleting from, and modifying the group of fraud detection actions.

18. The computer-readable storage medium of claim 13, wherein mitigating potential fraud comprises enabling the fraud engine to initiate one or more fraud mitigation actions for a candidate request, the candidate request comprising a candidate request machine identity, a candidate request timestamp, and a candidate request content type,
enabling the fraud engine comprising:
finding one or more occurrences corresponding to the candidate request machine identity in at least one of a group comprising the request history, the machine list, and the fraud detection log;
analyzing the one or more occurrences to determine a mitigation strategy, comprising selecting one or more fraud mitigation actions from a group comprising:
(a) allowing the candidate request,
(b) denying the candidate request,
(c) communicating an updated ad configuration;
(d) flagging the candidate request as potentially fraudulent,
(e) retrieving an impotent ad content corresponding to the candidate request content type and communicating the impotent ad content to a candidate computer corresponding to the candidate request machine identity, wherein the impotent ad content is uncorrelated to compensating the computer owner of the candidate computer,
(f) recording one or more fraud mitigation actions for execution after a future event occurs, the future event comprising one of a group comprising: receiving a subsequent ad request corresponding to the candidate request machine identity and exceeding a configurable threshold,
(g) traversing the request history, and for each request history entry, performing one or more of the fraud mitigation actions (a) through (f);
executing the one or more selected fraud mitigation actions; and
logging in the fraud detection log at least one of the group comprising the candidate request, the one or more selected fraud mitigation actions, and a fraud mitigation action timestamp.

19. The computer-readable storage medium of claim 13, further comprising enabling an interface for administrating the fraud engine, comprising: adding to, deleting from, and modifying the group of fraud mitigation actions and adding to and modifying a set of parameters for use by the fraud engine in determining the mitigation strategy,
wherein determining the mitigation strategy further comprises determining an execution sequence and a timing of selected mitigation actions based upon the set of parameters, and wherein the set of parameters comprises the configurable threshold.

20. The computer-readable storage medium of claim 13, wherein creating an owner account further comprises creating one or more records, wherein each record corresponds to a different client computer of the computer owner.
